(19) United States
(12) Patent Application Publication
(10) Pub. No.: US 2007/0077417 A1
(43) Pub. Date: Apr. 5, 2007

(54) Tear resistant sealable packaging structure

(76) Inventor: David H. Hawes, Raleigh, NC (US)

Correspondence Address: MEADWESTVACO CORPORATION, Division and Technical Center - Law Dept., PO BOX 118005, CHARLESTON, SC, 29423-8005, US

(21) Appl. No.: 11/545,842

(22) Filed: Oct. 11, 2006

Related U.S. Application Data
(63) Continuation-in-part of application No. 09/951,035, filed on Sep. 13, 2001, now Pat. No. 7,144,635.

(51) Int. Cl. B32B 27/34; B32B 27/30; B32B 27/10

(52) U.S. Cl. 428/339; 428/537.5; 428/513; 428/475.5; 428/522; 428/910

(57) ABSTRACT

A packaging structure including a paperboard substrate having a first side and a second side, a tear resistant film positioned over the first side of the paperboard substrate, wherein the tear resistant film includes at least one of an oriented film and a cross-laminated polyolefin film, and a sealing layer positioned over the tear resistant film such that the tear resistant film is positioned between the paperboard substrate and the sealing layer, wherein the packaging structure has a tear resistance, as measured by the Elmendorf tear propagation test, of at least about 337 gm-force.

This application is a continuation-in-part of U.S. Ser. No. 09/951,035, allowed, filed on Sep. 13, 2001, the entire contents of which are incorporated herein by reference.

### BACKGROUND

This application relates to flexible, multi-layer paperboard structures and, more particularly, to flexible, multi-layer paperboard structures that may be sealed by, for example, a heated platen, RF energy and/or ultrasonic energy, to form a tear resistant packaging material.

Use of sealable paperboard materials for packaging is described, for example, in U.S. Pat. No. 5,091,261 to Casey et al. This patent describes a laminate for packaging applications comprised of a paperboard substrate having one coated, printable surface (C1S), and having adhered to the opposing side a co-extrudate of low density polyethylene and an adhesive material, for example, ethylene methyl-acrylate copolymer. This adhesive material enables the laminate to be used for applications such as the manufacture of blister cards, which requires that a tight seal be formed between the laminate and the plastic material of the blister. In this regard, the adhesive material is a heat sealable component that plasticizes at low heat, so that when opposing surfaces treated with the same material are contacted, the adhesive material bonds together to form a seal.

U.S. Pat. No. 6,010,784 relates to a similar paperboard laminate, where an ethylene-vinyl acetate based hot melt forms the heat sealing layer, for pharmaceutical blister packaging. The hot melt layer seals to common blister forming films including polychlorotrifluoroethylene (Aclar®), a high barrier film.

The packaging laminates described in U.S. Pat. Nos. 5,091,261 and 6,010,784 exhibit the additional advantage of being clay-coated and thus printable on one side. Accordingly, they are suited to consumer packaging applications, for example, for packaging of unit dose pharmaceuticals. However, these products lacked high tear resistance and burst resistance, which are both characteristics desired for various packaging applications including but not limited to pharmaceutical packaging.

Unit dose packaging is an attractive packaging format for certain pharmaceutical applications because it is convenient, yet sturdy enough to be opened and closed numerous times until the course of medication is completed, and also enables the user to track the consumption of doses according to the prescribed schedule. Examples of such packaging are described in commonly assigned U.S. Pat. No. 6,047,829 to Johnstone. The Johnstone patent relates to a unit dose paperboard package that includes an outer paperboard sleeve, an inner paperboard slide card that is lockably retained within the sleeve. The sleeve includes a plurality of side panels operatively connected to each other such that one of said plurality of side panels includes a first inner slide card releasing means, and another of said side panels includes a second inner slide card releasing means, such that the inner slide card retaining and releasing means are located substantially adjacent to said unit dose dispensing means.

Child resistance is a feature particularly desired for unit dose pharmaceutical packaging, and is mandated by the Poison Prevention Packaging Act of 1970. Guidelines are prescribed for packaging to satisfy the criteria for child resistance under the statute. For example, a child resistance (CR) rating of F=1 requires that a random sampling of the subject packages not be compromised by an age specific test pool of children at a failure rate of greater than 10%. This general guideline is designed to ensure that the package has sufficient integrity against tampering by children.

While modifying package design provides one avenue for improving child resistance, it would also be beneficial to provide similar improved tolerance in packages having a known or more conventional design and construction. In this respect, improving tear resistance is necessarily accomplished by developing packaging materials having such characteristics. At the same time, it is preferred that such packaging material also have a heat sealing ability suited to secure packaging of consumable goods.

Accordingly, there is a need for a tear resistant packaging structure capable of being sealed.

### SUMMARY

In one aspect, the disclosed packaging structure includes a laminated structure comprised of a paperboard substrate, one or more layers of a tear resistant material, one or more layers of a sealable component and, optionally, one or more polyolefin tie layers.

In another aspect, the disclosed method of packaging an article in a tear resistant packaging structure includes forming a packaging blank from a tear resistant laminate composed of a paper or paperboard substrate, a tear resistant layer, a polyolefin tie layer interposed between the substrate and the tear resistant layer, and a layer of sealable component, folding the blank and sealing the exposed sealable component at the points of contact to form a container, and inserting an article within the container.

In yet another aspect, the disclosed method for securing packaging of consumable goods includes forming one or more portions of a packaging container from a tear resistant laminated structure formed by extruding a tie layer between a paperboard substrate and a tear resistant layer and extruding one or more layers of a sealable component over the tear resistant layer to form a tear resistant laminated structure, and, optionally, printing text or graphics on the side of the paperboard substrate opposite the tear resistant layer, cutting the laminated structure to form a packaging blank, folding the packaging blank and sealing the exposed sealable component at the points of contact to form a container, and inserting a consumable good within the container interior. Alternatively, the packaging may be formed around the good as, for example, in a blister card.

Other aspects of the disclosed packaging structure and associated methods will become apparent from the following description, the accompanying drawings and the appended claims.

### BRIEF DESCRIPTION OF THE DRAWINGS

FIG. 1A is a cross-sectional view of one aspect of the disclosed packaging structure;

FIG. 1B is a cross-sectional view of a second aspect of the disclosed packaging structure;

FIG. 2 is a schematic illustration of one aspect of the disclosed process for making the packaging structure of FIG. 1A;

FIG. 3 is a schematic illustration of a second aspect of the disclosed process for making the packaging structure of FIG. 1A; and

FIG. 4 is a schematic illustration of one aspect of the disclosed process for making the packaging structure of FIG. 1B.

### DETAILED DESCRIPTION

The disclosure provides a packaging structure that is resistant to tearing or burst damage and thus provides more security to the package contents when it is used, for example, to form a folded box, envelope, blister card or other package. This feature is particularly desirable in the foldover blister packaging of pharmaceuticals where regulatory guidelines specify a certain acceptable level of child resistance. At the same time, the package must be user-friendly, fitted for frequent repeat usage and easily manipulated by the consumer.

The disclosed packaging structure may include one or more materials that, alone or in combination, produce the resilience that has now been discovered.

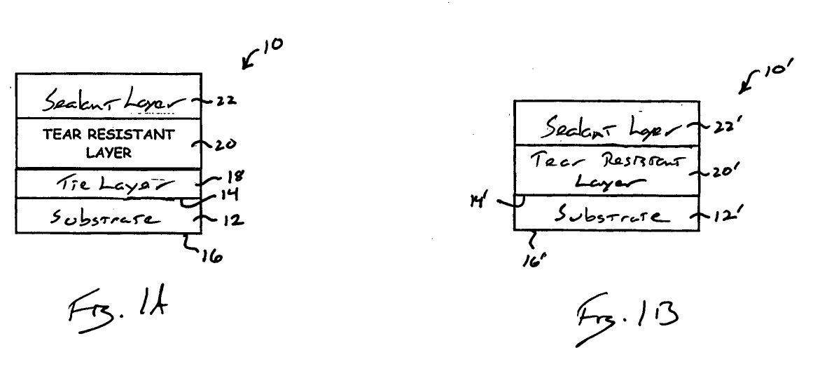

Referring to FIG. 1A, one aspect of the disclosed packaging structure, generally designated 10, may include a substrate layer 12 having a first surface 14 and a second surface 16, a tie layer 18 positioned over the first surface 14 of the substrate 12, a tear resistant layer 20 positioned over the tie layer 18 and a sealing layer 22 positioned over the tear resistant layer 20. In an alternative aspect, the packaging structure, generally designated 10′ in FIG. 1B, may include a substrate layer 12′, a tear resistant layer 20′ and a sealing layer 22′, without a tie layer positioned between the substrate layer 12′ and the tear resistant layer 20′.

The substrate layer 12, 12′ may be selected from any conventional paperboard grade, such as solid bleached sulfate (SBS), coated natural kraft, folding boxboard and recycled board, and may have a weight of about 10 pt. or greater, preferably from about 11 pt. to about 14 pt. An example of such a substrate is a 12-point SBS board manufactured by MeadWestvaco Corporation. The substrate 12, 12′ may also be an unbleached board, depending on the desired appearance of the final package.

The substrate layer 12, 12′ may be preferably coated on at least one side, preferably the side opposite the lamination (i.e., the second side 16, 16′), with a coating selected for compatibility with the printing method and board composition (e.g., clay). The coated side 16, 16′ may be presented on the external surface of a package formed from the disclosed packaging structure 10, 10′ to allow for printing of text or graphics on the external surface.

To the uncoated side 14, 14′ of the substrate 10, 10′ may be applied at least one layer of a tear resistant polymeric material 20, 20′. The tear resistant layer 20, 20′ imparts toughness to the laminate structure and may be applied as a film, an extrusion, a solvent-born application, a water-born application or the like.

Suitable materials to be used in the tear resistant layer 20, 20′ include oriented films (e.g., unidirectionally oriented films and biaxially oriented films). Examples of oriented films may include MYLAR™, which is a biaxially oriented polyester, oriented nylon (e.g., DARTEK™) and cross-laminated polyolefin films such as VALERON™ or INTEPLUS™, which are high density polyolefins. The orientation and cross-laminated structure of these materials contribute to the tear resistant characteristic. Also, tear resistance may be attributed to the chemical nature of the tear resistant material. An example of a chemically strengthened material is extruded metallocene-catalyzed polyethylene (mPE).

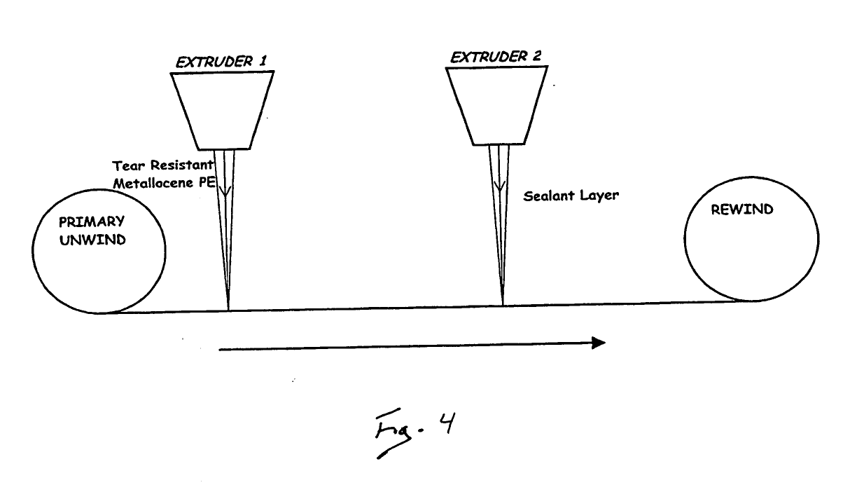

Alternatively, the tear resistant layer 20, 20′ may be an extrusion-coated layer of, for example, LLDPE or mPE, as shown in FIG. 4. Other suitable flexible materials having a high level of tear resistance may also be used. It has now been found that various combinations of these materials in which at least one layer of the tear resistant material and the sealing layer, when applied to a bleached board substrate, produce the favored tear resistance performance.

Where a sheet material such as oriented polyester or nylon or cross-laminated is used as the tear resistant layer 20, 20′, a caliper ranging from about 0.75 mils (approximately 16 lb./ream) or more is preferred. As used herein, ream size is approximately 3000 ft². For example, a suitable caliper of tear resistant material may range from about 0.75 mils or more, preferably from about 1 mil to about 5 mils.

In embodiments in which the tear resistant layer 20, 20′ is formed from a bulk polymer material that is extruded onto the substrate, the polymer melt is extruded to yield a coat weight of from about 10.8 to about 70 lb./ream, preferably 14.5 to about 35 lb./ream.

A tie layer 18 optionally may be interposed between the substrate layer 12 and the tear resistant layer 20, as shown in FIGS. 1A, 2 and 3. The tie layer 18 may be formed by a polyolefin material, which acts as a tie layer and also imparts flexibility to the laminate. A preferred polyolefin for this purpose is LDPE or linear low-density polyethylene (LLDPE). Alternatively, polylactic acid may be used in the tie layer 18 and may be extruded or applied as a solvent-born or water-born material. In various embodiments where LLDPE or mPE is used, however, it may not be necessary to incorporate an additional tie layer 18, as shown in FIGS. 1B and 4.

It should also be noted that one or more types and/or layers of the tear resistant material 20, 20′, tie layer 18 and sealing layer 22, 22′ may be included in various embodiments of the laminated structure.

The sealing layer 22, 22′ may be applied by a process such as melt extrusion, film coating, spraying, roll coating or other means. The sealing layer 22, 22′ may serve as an adhesive that bonds the layers of the laminate together upon application of heat (e.g., a heated platen), RF energy and/or ultrasonic energy. An example of a sealable material useful for the sealable layer 22, 22′ is ethylene vinyl acetate (EVA), which may form a seal under heat or upon exposure to RF energy and ultrasonic energy. Examples of heat sealable materials include ethylene methyl acrylate (EMA), copolymers of EVA and EMA, and combinations of EVA and/or EMA and other polymers or materials. Those skilled in the art will appreciate that other sealing techniques and sealable materials may be used for the sealing layer 22, 22′

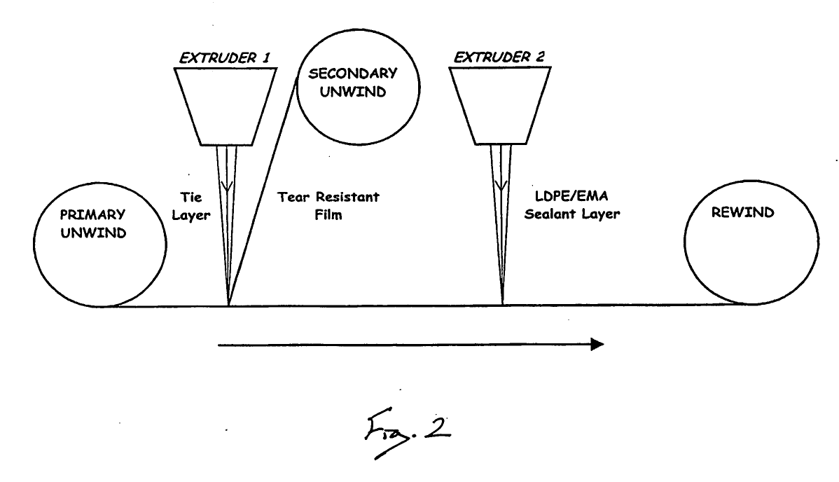

Preferably, the sealing layer 22, 22′ is applied by melt extrusion either by co-extruding simultaneously or in tandem with the tie layer at a coat weight of from about 5 to about 14 lb./ream, preferably about 8 to 10 lb./ream. The process of co-extruding the tie layer 18 and sealing layer 22, 22′, as shown in FIG. 2, is described in detail in U.S. Pat. No. 5,091,261, the entire contents of which are incorporated herein by reference.

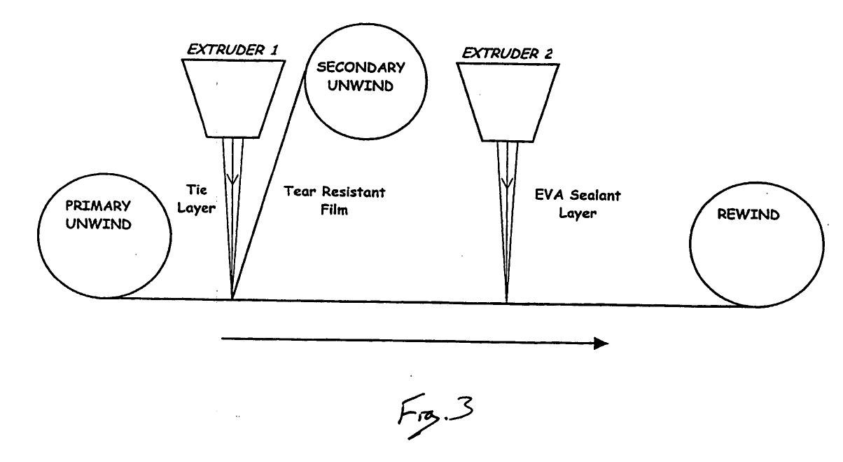

In one embodiment, as shown in FIG. 2, a packaging structure 10 may be formed in an in-line operation by unwinding a C1S paperboard substrate 12, overlaying the substrate 12 and simultaneously extruding a tie layer 18 (e.g., LDPE) and tear resistant film 20 onto one side 14 of the substrate 12. A layer 22, 22′ of a sealing material, which may be a combination of LDPE and EMA, may be extruded over the tear resistant substrate 20. Referring to FIG. 3, the sealing layer 22 may be a single component, namely EVA. Alternatively, as shown in FIG. 4, both the tear resistant layer 20′ and the sealing layer 22′ may be co-extruded. In such an application, a chemically strengthened material such as mPE, which may be extruded without compromise to its strength characteristics, may be used as the tear resistant layer 20′.

The resulting flexible, packaging structure 10, 10′ may be used in any packaging application where tear resistance is required. One of many such applications is the packaging of pharmaceuticals such as prescription medications. In one exemplary application, the packaging structure 10, 10′ may be used to form the outer packaging of a box housing unit dose medications. In such an embodiment, the medications may be housed in individual doses on a blister card that is contained within the box interior. The box blank may be configured and folded to provide a retention means for the blister card, thereby preventing its complete withdrawal from the package interior. Such retention means are disclosed, for example in U.S. Pat. No. 6,047,829 (Johnstone). In the alternative, the blister card may be unattached so as to allow its complete withdrawal from the package, if desired. Packaging of other articles such as dry or semi-moist foods, cosmetics, small electronics, recording media such as CDs and tapes and various other articles are also contemplated and should be viewed as falling within the scope of this disclosure. The laminate structure of the invention may, however, also be manufactured using a lighter weight paperboard substrate or even a paper, for example, envelope grade material, to manufacture other types of containers such as envelopes or mailers. The range of potential applications is therefore quite extensive for this versatile composition.

### EXAMPLES

The following examples are non-limiting and are provided for illustrative purposes only.

### EXAMPLE 1

Tear resistance of several extrusion coatable polymers coated onto 61-lb. weight paper substrate were evaluated and reported in Table 1. Tear resistance was determined as grams force in the machine- and cross- directions (MD and CD, respectively). Burst strength was reported in pounds per square inch (psi).

As shown, metallocene-catalyzed polyethylene (mPE) demonstrated significantly greater tear resistance than LDPE, EMA, cross-laminated film (VALERON™), and ionomer (cationically neutralized EMA copolymer, DuPont), when coated onto the substrate.

TABLE 1

| | | Layer Type: | | | | | |
|---|---|---|---|---|---|---|---|
| | | | 2.5 mil | 1 mil | 0.75 mil | 1 mil | 1 mil |
| | Substrate: | | Valeron ™ | LDPE on | EMA on | ionomer | mPE on |
| Measurement | 61# Paper | Tyvek ™ | on 80# Paper | 61# Paper | 61# Paper | on 61# Paper | 61# Paper |
| Total Caliper (mils) | 5 | 5.9 | 8.8 | 5.8 | 5.5 | 5.8 | 5.7 |
| Basis Weight (lbs./1000 sq. ft.) | 17.6 | 11.7 | 41.7 | 22.3 | 21.4 | 23.2 | 23.9 |
| MD Tear (gm-force) | 80 | 592 | 511 | 63 | 117 | 97 | 525 |
| CD Tear (gm-force) | 93 | 622 | 834 | 67 | 121 | 103 | 507 |
| Burst Resistance (psi) | 36.8 | 113 | 52 | 40.2 | 37.2 | 37.8 | 35.8 |

### EXAMPLE 2

An example of tear resistant layer material was also evaluated to determine the effect of layer thickness on tear resistance and burst resistance, again by measuring tear and burst resistance as described above. In this example, mPE was used. Coatings were applied at calipers of from about 1 mil to about 5 mils (approximately 14 lb./ream to about 67.2 lb./ream coat weight, respectively). The results are reported in Table 2.

TABLE 2

| | | | 2.5 mil | | | | | | |
|---|---|---|---|---|---|---|---|---|---|
| | 61# | | Valeron ™ | Increasing Coat Weight of mPE on 61# Paper | | | | | |
| Measurement | Paper | Tyvek ™ | on 80# Paper | 1 mil | 2 mil | 2.5 mil | 3 mil | 4 mil | 5 mil |
| Total Caliper (mils) | 5 | 5.9 | 8.8 | 5.7 | 6.7 | 7.1 | 7.5 | 8.7 | 9.5 |
| Basis Weight (lbs./1000 sq. ft.) | 17.6 | 11.7 | 41.7 | 23.9 | 28.7 | 30.2 | 31.8 | 38.2 | 41.8 |
| MD Tear (gm-force) | 80 | 592 | 511 | 525 | 664 | 734 | 605 | 976 | 1246 |
| CD Tear (gm-force) | 93 | 622 | 834 | 507 | 645 | 864 | 750 | 1108 | 1208 |
| Burst Resistance (psi) | 36.8 | 113 | 52 | 35.8 | 38.6 | 38.8 | 40.6 | 44 | 46.2 |

Table 2 indicates the mPE coated at a range of thickness from 1 mil upward provides good tear resistance.

### EXAMPLE 3

Laminated structures according to various embodiments are prepared according to the combinations recited in Table 3.

TABLE 3

| | Tear Resistant | |
|---|---|---|
| Substrate | Material | Sealable Material |
| 12 pt. | Metallocene | LDPE/EMA coextrusion |
| SBS | polyethylene | or EVA monolayer |
| 13 pt. | Oriented polyester | LDPE/EMA coextrusion |
| SBS | | or EVA monolayer |
| 14 pt. | Cross-laminated film | LDPE/EMA coextrusion |
| SBS | | or EVA monolayer |

wherein SBS is bleached sulfate board, EMA is ethylene methyl acrylate copolymer, such as Optima TC220 (ExxonMobil) or SP 2260 (Eastman Chemical), and EVA is ethylene vinyl acetate copolymer, such as HL9918X (H. B. Fuller).

### EXAMPLE 4

The tear resistance of various disclosed structures was evaluated. Laminates were prepared by layering metallocene-catalyzed polyethylene, 2.5 mils (35 lbs./3000 ft.²) or, alternatively, biaxially oriented polyester, 0.75 mils ( 16 lbs./3000 ft.²) on 12 or 14 point SBS paperboard. The sealing layer (Hot melt HL9918X, from H. B. Fuller) was applied by melt extrusion at a coat weight of about 9 lbs./3000 ft.²) Multiple samples of equivalent dimension were subjected to the Elmendorf tear propagation resistance evaluation, the results being measured in grams-force. The samples were also tested using the Graves tear test to determine tear initiation resistance at maximum load. The results are reported in Table 4.

TABLE 4

| | | | Basis | Elmendorf | | | |
|---|---|---|---|---|---|---|---|
| | | | Weight | Tear (gm- | | Graves Tear | |
| Sam- | Laminate | Caliper | (lbs./ | force) | | (lbf./in.) | |
| ple | Composition | (mils) | 3000 ft²) | MD | CD | MD | CD |
| C | 12 pt. SBS/ | 14.71 | 197.97 | 761 | 823 | 29.7 | 20.3 |
| | metallocene- | | | | | | |
| | catalyzed PE | | | | | | |
| D | 14 pt. SBS/ | 15.84 | 211.20 | 359 | 337 | 37.2 | 29.2 |
| | biaxially | | | | | | |
| | oriented | | | | | | |
| | polyester | | | | | | |
| E | 14 pt. SBS/ | 18.32 | 233.97 | 1432 | 807 | 35.0 | 25.9 |
| | cross- | | | | | | |
| | laminated film | | | | | | |

wherein MD is machine direction and CD is cross direction.

The tear resistance performance demonstrated in Table 4 indicates that laminates incorporating metallocene-catalyzed polyethylene have good tear propagation resistance; laminates incorporating biaxially oriented polyester have good tear initiation resistance; and laminates incorporating cross-laminated film have excellent overall tear strength, showing both good tear initiation and tear propagation resistance.

### EXAMPLE 5

The tear resistance of various disclosed packaging structures was evaluated. Sample A (control) was a 30 pt. paperboard material having a clay coating on one side. Sample B was a 30 pt. paperboard material having a clay coating on one side and a tie layer of LDPE and a tear resistant layer of Valeron™ film (2.5 mil) on the other side, wherein the paperboard material was flame treated prior to coating with the tear-resistant material. Sample C was a 30 pt. paperboard material having a clay coating on one side and a tie layer of LDPE and a tear resistant layer of Valeron™ film (2.5 mil) on the other side, wherein the paperboard material was not flame treated prior to coating prior to coating with the tear-resistant material. A sealing layer (e.g., LDPE/EMA or EVA), which is not believed to provide significant tear resistance, was not applied for the purposes of tear testing. Tear testing was performed on Samples A, B and C and the results are provided in Table 5:

TABLE 5

| | | Elmendorf Tear (gm-force) | | | | | | |
|---|---|---|---|---|---|---|---|---|
| | | Test 1 | Test 2 | Test 3 | Test 4 | Test 5 | Average | Std. Dev. |
| Sample | MD | 809.6 | 736.0 | 764.8 | 729.6 | 838.4 | 775.7 | 47.2 |
| A | CD | 883.2 | 803.2 | 1014.4 | 950.4 | 1148.8 | 960.0 | 131.5 |
| Sample | MD | 2544.0 | 2684.8 | 2457.6 | 2476.8 | 2502.4 | 2533.1 | 90.8 |
| B | CD | 1539.2 | 1632.0 | 1632.0 | 1872.0 | 1753.6 | 1685.8 | 129.0 |
| Sample | MD | 2249.6 | 2374.4 | 1977.6 | 2768.0 | 2652.8 | 2404.5 | 316.6 |
| C | CD | 1830.4 | 1670.4 | 1884.8 | 2028.8 | 2028.8 | 1888.6 | 150.3 |

Thus, Table 5 indicates that a layer of Valeron™ film provides significant tear resistance.

Although various aspects and embodiments of the disclosed packaging structures and associated systems and methods have been shown and described, modifications may occur to those skilled in the art upon reading the specification. The present application includes such modifications and is limited only by the scope of the claims.

What is claimed is:

1. A packaging structure comprising:
a paperboard substrate having a first side and a second side;
a tear resistant layer positioned over said first side of said paperboard substrate, wherein said tear resistant layer includes at least one of an oriented film and a cross-laminated polyolefin film; and
a sealing layer positioned over said tear resistant layer such that said tear resistant layer is positioned between said paperboard substrate and said sealing layer,
wherein said packaging structure has a tear resistance, as measured by the Elmendorf tear propagation test, of at least about 337 gm-force.

2. The packaging structure of claim 1 further comprising a coating applied to said second side of said paperboard substrate.

3. The packaging structure of claim 2 wherein said coating is clay.

4. The packaging structure of claim 1 wherein said oriented film is a biaxially oriented polyester film.

5. The packaging structure of claim 1 wherein said oriented film is an oriented nylon film.

6. The packaging structure of claim 1 wherein said cross-laminated polyolefin film is a cross-laminated high density polyolefin film.

7. The packaging structure of claim 1 wherein the sealing layer includes at least one of a heat sealable material, an RF sealable material and an ultrasonic sealable material.

8. The packaging structure of claim 1 wherein said sealing layer includes at least one of an ethylene vinyl acetate and an ethylene methyl acrylate.

9. The packaging structure of claim 1 wherein said tear resistance of said packaging structure is in a range of about 337 to about 2768 gm-force.

10. The packaging structure of claim 1 wherein said tear resistance of said packaging structure is in a range of about 1539 to about 2768 gm-force.

11. The packaging structure of claim 1 further comprising a tie layer positioned between said paperboard substrate and said tear resistant layer.

12. The packaging structure of claim 10 wherein said tie layer includes at least one of a low density polyethylene and a linear low density polyethylene.

13. The packaging structure of claim 1 wherein said tear resistant layer has a thickness of about 1 to about 5 mils.

14. A packaging structure comprising:
a paperboard substrate having a first side and a second side;
a biaxially oriented polyester film positioned over said first side of said paperboard substrate;
a tie layer positioned between said paperboard substrate and said biaxially oriented polyester film, said tie layer including at least one of a low density polyethylene and a linear low density polyethylene; and
a sealing layer positioned over said biaxially oriented polyester film such that said biaxially oriented polyester film is positioned between said paperboard substrate and said sealing layer,
wherein said packaging structure has a tear resistance, as measured by the Elmendorf tear propagation test, of at least about 500 gm-force.

15. A packaging structure comprising:
a paperboard substrate having a first side and a second side;
a metallocene-catalyzed polyethylene layer positioned over said first side of said paperboard substrate; and
a sealing layer positioned over said metallocene-catalyzed polyethylene layer such that said metallocene-catalyzed polyethylene layer is positioned between said paperboard substrate and said sealing layer,
wherein said packaging structure has a tear resistance, as measured by the Elmendorf tear propagation test, of at least about 500 gm-force.
